(19) United States
(12) Patent Application Publication
(10) Pub. No.: US 2013/0255972 A1
(43) Pub. Date: Oct. 3, 2013

(54) RAILROAD MAINTENANCE BIODEGRADABLE PSEUDOPLASTIC FIRE SUPPRESSION

(71) Applicants: James Alroy E. Hagquist, St. Paul, MN (US); Terrance L. Lund, Woodbury, MN (US); Roderick I. Lund, Woodbury, MN (US)

(72) Inventors: James Alroy E. Hagquist, St. Paul, MN (US); Robert M. Hume, III, Woodbury, MN (US); Terrance L. Lund, Woodbury, MN (US); Roderick I. Lund, Woodbury, MN (US)

(73) Assignee: EARTHCLEAN CORPORATION, South St. Paul, MN (US)

(21) Appl. No.: 13/884,991

(22) PCT Filed: Nov. 15, 2011
(86) PCT No.: PCT/US11/60755

§ 371 Date: Jun. 18, 2013

Related U.S. Application Data
(60) Provisional application No. 61/414,054, filed on Nov. 16, 2010.

(51) Int. Cl. A62D 1/00; B61D 5/00

(52) U.S. Cl. CPC A62D 1/00; B61D 5/00
USPC 169/46; 105/358

(57) ABSTRACT

Method of extinguishing or suppressing fire includes applying a pseudoplastic composition onto a railroad track or railroad right-of-way. The pseudoplastic composition clings to a surface positioned in any orientation. The pseudoplastic composition includes starch, a pseudoplastic, high yield, suspending agent, and water. Apparatus for applying the pseudoplastic composition onto a railroad track or railroad right-of-way are also disclosed.

### FIELD

This disclosure relates to pseudoplastic compositions for railroad maintenance and fire suppression on railroad right of ways.

### BACKGROUND

Railroad track and railroad right-of-way maintenance includes a large number of activities. These activities include rail grinding, replacement of rail or ties, and general fire suppression, for example. Some rail maintenance activities generate heat or sparks such as rail grinding, for example.

Rails in both railroad and light rail (e.g., inner-metropolitan transport for persons) applications are subject to wear by the passage of trains over the rails. In particular, depressions in the upper surface of a rail may develop such that the railhead presents an undulating, corrugated surface. Moreover, the rail may develop burrs and cracks, or otherwise lose its symmetrical profile (the profile that is transverse to the rail longitudinal axis). Maintenance of a smooth running surface on the railhead of a rail for railroad and light rail applications is important for reasons of safety, riding comfort, noise suppression, reduced maintenance of the track and track bed, and protection of the track, track bed and rolling stock.

Grinding machines for maintaining the railhead of rails in smooth, properly shaped condition have a plurality of rotatable grinding modules carried on a grinding vehicle and pulled by a locomotive or the like, and disposed in close proximity to the railhead surface of the rail. The grinding modules include rotatable, abrasive grinding stones that can be lowered into a position where a portion of the grinding stone bears on the rail surface. The grinding stones then grind and restore the surface of the railhead to a smooth properly profiled configuration.

These grinding machines produce heat and sparks that can lead to a fire in the railroad track or in the railroad right-of-way. Attempts to suppress railroad track or in the railroad right-of-way fires may cause “slippery conditions” on work surfaces or equipment. For example, freezing water on railroad track or in the railroad right-of-way surfaces and equipment can present a “slippery condition”.

### BRIEF SUMMARY

The present disclosure relates to railroad maintenance biodegradable pseudoplastic compositions. In particular the present disclosure relates to railroad maintenance pseudoplastic compositions that are useful for a number of railroad maintenance activities.

In one illustrative embodiment, a method includes applying a pseudoplastic composition onto a railroad track or railroad right-of-way. The pseudoplastic composition clings to a surface positioned in any orientation. The pseudoplastic composition includes starch, a pseudoplastic, high yield, suspending agent, and water.

In another illustrative embodiment, a method of extinguishing or suppressing fire includes applying a pseudoplastic composition onto a railroad track or railroad right-of-way. The pseudoplastic composition clings to a surface positioned in any orientation. The pseudoplastic composition includes starch, a pseudoplastic, high yield, suspending agent, and water.

An illustrative apparatus includes a railroad vehicle, a liquid reservoir disposed on the railroad vehicle, a pseudoplastic composition disposed in the liquid reservoir and a spray nozzle fluidly connected to the liquid reservoir disposed on the vehicle. The spray nozzle is configured to direct the pseudoplastic composition onto a railroad track or railroad right-of-way. The pseudoplastic composition clings to a surface positioned in any orientation. The pseudoplastic composition includes starch, a pseudoplastic, high yield, suspending agent, and water.

An illustrative apparatus for extinguishing or suppressing fire includes a railroad vehicle, a liquid reservoir disposed on the railroad vehicle, a pseudoplastic composition disposed in the liquid reservoir and a spray nozzle fluidly connected to the liquid reservoir disposed on the vehicle. The spray nozzle is configured to direct the pseudoplastic composition onto a railroad track or railroad right-of-way. The pseudoplastic composition clings to a surface positioned in any orientation. The pseudoplastic composition includes starch, a pseudoplastic, high yield, suspending agent, and water.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram side elevation view of an illustrative railroad maintenance apparatus; and

FIG. 2 is a schematic diagram side elevation view of another illustrative railroad maintenance apparatus.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, it is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to railroad maintenance biodegradable pseudoplastic compositions. In particular the present disclosure relates to biodegradable pseudoplastic compositions that are useful for a number of railroad maintenance and fire rail suppression activities. The biodegradable pseudoplastic composition includes starch, a pseudoplastic, high yield, suspending agent, and water. The pseudoplastic composition clings to a surface positioned in any orientation. While the present disclosure is not so limited, an appreciation of various aspects of the disclosure will be gained through a discussion of the examples provided below.

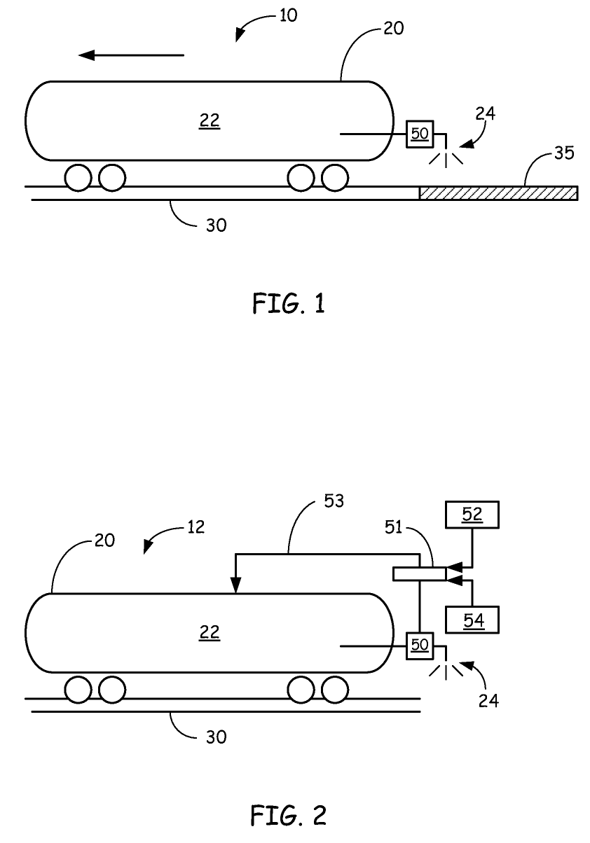

FIG. 1 is a schematic diagram side elevation view of an illustrative railroad maintenance apparatus 10. The apparatus 10 includes a railroad vehicle 20, and a liquid reservoir 22 disposed on the railroad vehicle 20. A pseudoplastic composition is disposed in the liquid reservoir 22. A spray nozzle 24 is fluidly connected to the liquid reservoir 22. The spray nozzle 24 is configured to direct the pseudoplastic composition onto a railroad track 30 or railroad right-of-way. The pseudoplastic composition can be pumped out of the spray nozzle 24 and directed toward the railroad track 30 or railroad right-of-way. The pseudoplastic composition clings to a surface positioned in any orientation 35. The pseudoplastic composition includes starch, a pseudoplastic, high yield, suspending agent, and water.

FIG. 2 is a schematic diagram side elevation view of another illustrative railroad maintenance apparatus 12. The apparatus 12 includes a railroad vehicle 20, a liquid reservoir 22 disposed on the railroad vehicle 20 and product recirculation piping 53. The product recirculation piping 53 includes a fluid pump 50 fluidly connected to the liquid reservoir 22 and an eductor 51 or other mixing device, fluidly connected to the fluid pump 50. A powder concentrate container 52 and/or a liquid concentrate container 52 are connected to the eductor 51 to supply the powder concentrate or liquid concrete compositions to the eductor 51 and form the pseudoplastic compositions described herein. In other embodiments, the powder concentrate or liquid concrete compositions can be directly poured into the liquid reservoir 22 to form the pseudoplastic compositions described herein.

In many embodiments, the pseudoplastic compositions include pseudoplastic high yield suspending agents, starch, and a basic neutralizing material, added to water to produce a stable, nonsettling augmentation to water (e.g., an aqueous suspension). In some embodiments, paraffin or olefin is added to the pseudoplastic compositions, as desired. Other materials can be added to the pseudoplastic compositions depending on the desired use of the pseudoplastic compositions, as described below.

The pseudoplastic compositions can be applied to a railroad track or railroad right-of-way by spraying the pseudoplastic composition at the desired surface. The pseudoplastic compositions have the ability to cling to the surface applied to. In some embodiments the pseudoplastic compositions are applied to a railroad track or a railroad right-of-way to prevent or suppress or extinguish a fire. In some embodiments the pseudoplastic compositions are applied to a railroad track to control the temperature or cooling or heating of the rail. In some embodiments the pseudoplastic compositions are applied to a railroad track to provide slip resistance (e.g., personal safety on working surfaces) to the rail work areas. In some embodiments the pseudoplastic compositions are applied to provide two or more of the above-identified advantages.

The aqueous suspension or pseudoplastic composition is easily pumped or sprayed by pumping equipment or by low-pressure individual back tanks. The pseudoplastic composition has a “high yield value,” meaning it has an initial resistance to flow under stress but then is shear thinning (where the viscosity decreases with increasing rate of shear stress), and when used, exhibits “vertical cling,” meaning it has the ability at rest, to immediately return to a suspension or gel. The pseudoplastic composition can be easily sprayed and immediately thickens when it contacts a railroad track surface or railroad right-of-way surface. The pseudoplastic composition's mass and the vertical cling both can act as a heat sink capable of clinging to vertical and overhead surfaces. This clinging to the surfaces is useful for a number of railroad maintenance activities.

For example, the heat sink effect does not allow the temperature of the surface coated with the pseudoplastic composition to exceed about 100 degree centigrade until all the water in the pseudoplastic composition has been evaporated. To produce this shear thinning effect and then cling, the composition uses a pseudoplastic high yield-suspending agent.

In many embodiments the pseudoplastic composition is formed from starch, a pseudoplastic, high yield, suspending agent, and a basic neutralizing material. These materials can be mixed or blended utilizing a mixer to obtain a powered composition. It has been found that these compositions quickly form a stable suspension or pseudoplastic composition when combined with water. In many embodiments, the pseudoplastic suspension or composition has a pH in the range of 5.0 to 8.0 and clings to a surface positioned in any orientation. In some useful fire suppression or fire extinguishing railroad applications the pseudoplastic composition forms an exterior intumescent char coating upon fire contact, while retaining an interior aqueous gel composition.

In many embodiments a powdered composition includes 25-55 wt % pseudoplastic, high yield, suspending agent, 0.001-65% or 35-65 wt % starch, optionally 0.1-10 wt % paraffin or olefin, and 0.5-15 wt % basic neutralizing material. In many embodiments the composition (e.g., powdered composition) includes 30-50 wt % pseudoplastic, high yield, suspending agent, 0.001-60 or 40-60 wt % starch, optionally 1-5 wt % paraffin or olefin, and 0.5-10 wt % basic neutralizing material.

In many embodiments a liquid concentrate composition includes 10-40 wt % pseudoplastic, high yield, suspending agent, 10-40 wt % starch, 30-60 wt % paraffin or olefin, 0.1-10 wt % surfactant and 0.1-10 wt % basic neutralizing material. In many embodiments a liquid concentrate composition includes 20-30 wt % pseudoplastic, high yield, suspending agent, 20-30 wt % starch, 40-50 wt % paraffin or olefin, 1-5 wt % surfactant and 1-5 wt % basic neutralizing material.

These compositions can be diluted with water to form the pseudoplastic composition (an aqueous pseudoplastic suspension or composition). In many embodiments the pseudoplastic composition includes from 0.1 to 5% wt of the liquid or powder concentrate composition and from 99.9 to 95% wt water. In some embodiments, the pseudoplastic composition includes from 0.5 to 1% wt of the pseudoplastic composition and from 99.5 to 99% wt water. It has been found that the pseudoplastic composition clings to a surface positioned in any orientation, and often forms an exterior intumescent char coating upon fire contact, while retaining an interior aqueous gel composition.

There are many types of pseudoplastic high yield suspending agents or rheology modifiers that can be used successfully in the pseudoplastic composition. Two of the major groups of such suspending agents are laponites, a synthetic smectite clay, and CARBOPOLS™ (that are generally high molecular weigh homo- and copolymers of acrylic acid cross linked with a polyalkenyl polyether. Other polymers and synthetic clays are suitable and may be used in combination to develop special pseudoplastic high yield suspending agent characteristics. In using a combination of these suspending agents, synergism is found, for example, between laponites and CARBOPOLS™, where a blend offers improved characteristics for the composition. Thus a pseudoplastic, high yield, suspending agent can include a mixture of an acrylic acid copolymer cross linked with a polyalkenyl polyether (e.g., CARBOPOLS™) and a synthetic smectite clay. Of the group of laponites, which are synthetic smectite clays closely resembling the natural clay mineral hectoritic, it was found that Laponites RD and RDS provide the best performance. Laponites RD and RDS are layered hydrous magnesium silicates that disperse rapidly in water without the need for high shear. Laponites RD and RDS are manufactured by Southern Clay Products, Inc., Gonzales, Tex., and are commercially available from Fitz Chemical Corporation, Itasca, Ill.

In another major group of suspending agents, the CARBOPOLS™, one particularly effective material is CARBOPOLS™ EZ-3, a hydrophobically modified cross-linked polyacrylate powder. The polymer is self-wetting and requires low agitation for dispersion. The convenience of low agitation is very evident in the very short wetting out time needed, when making a concentrate. CARBOPOLS™ EZ-3 is commercially available from Noveon, Inc., Cleveland, Ohio 44141. These materials hold solid particles in suspension without allowing the solids to settle. These materials have a shear thinning rheology so they can be pumped or sprayed onto a surface without the loss of cling. The CARBOPOLS™ EZ-3 is the more efficient of pseudoplastic high yield suspending agents tested and the Laponite RDS one of the fastest to build in viscosity, after shear thinning. The laponites are especially sensitive to electrolytes or the typical salts in water. Many pseudoplastic high yield suspending agents need to be fully dispersed and hydrated in water to achieve the best performance characteristics. The suspension composition improves the overall efficiency of putting fire out with water. Other suitable pseudoplastic, high yield, suspending agents include modified guar and xantham gums, casein, alginates, modified cellulose, including methyl cellulose, hydroxyethyl cellulose, hydroxypropyl cellulose and carbomethyl cellulose, gum tragacanth used individually or in combination.

The pseudoplastic composition have a high yield value with a “shear thinning capacity” which means, the pseudoplastic composition becomes thin when pumped and instantly pseudoplastic or sag resistant, at rest. Thus, after being pumped and sprayed, the pseudoplastic composition is capable of clinging to a vertical or overhead surface. Any starch can be used in the suspension compositions. Examples of starches include corn, wheat, potato, tapioca, barley, arrowroot, rice or any combination of starches.

Dry starch contains about 12% water and has a particle size in a range from 1 to 50 micrometers. As the starch/water mixture is heated, for example by a fire or a hot rail or track or right-of-way, the starch forms a gel or association with all the surrounding water starting around 70 degrees centigrade. Thus, when the composition is heated, either from the substrate or the air side, the starch absorbs more water at the interface and becomes thicker. On the substrate side, the composition first rides on its own vapor and, as it cools, forms its own film on the substrate surface. On the air side, where evaporation largely occurs, the composition first thickens and then crusts over and eventually is converted to a carbonized char. The char formed is a hard, intumescent coating, which slows the evaporation of water from the composition. In essence, the composition's own film and char act as a vessel to contain the soft-gelled composition, which now acts as a heat sink to cool the backside of the intumescent char. This synergism between the intumescent hard coating and the composition's aqueous gel helps optimize a very limited amount of water. The char/gel coating further reduces the available combustible material to the fire, and also reduces the smoke emission. There are no dangerous chemical reactions caused by the application of the inventive composition and its byproducts are neither corrosive nor toxic.

Hydrophobic agglomerating material can be added to the composition. It has been found that the hydrophobic agglomerating material improves the material properties as compared to compositions that do not include the composition. While not wishing to be bound to any particular theory, it is believed that the hydrophobic agglomerating material improves the speed at which the aqueous gel or aqueous suspension is formed. In many fire suppression applications, quick formation of the aqueous gel or aqueous suspension is important.

In some embodiments the hydrophobic agglomerating material includes liquid paraffins or olefins. Paraffin is the common name for alkane hydrocarbons with the general formula CₙH₂ₙ₊₂. Liquid paraffin generally have less than 20 carbon atoms. In many embodiments the paraffin has from 10 to 15 carbon atoms and is linear, or has from 14 to 18 carbon atoms and is linear. Olefin is the common name for alkene hydrocarbons with the general formula CₙH₂ₙ where the hydrocarbon is not saturated. In many embodiments the olefin has from 10 to 15 carbon atoms and is linear, or has from 15 to 18 carbon atoms and is linear.

Commercially available paraffins and olefins include BIO-BASE™ 100LF (linear internal olefin with a carbon chain length between C15 and C18), BIO-BASE™ 300 (linear paraffin with a carbon chain length between C11 and C14), BIO-BASE™ 200 (linear alpha olefin with a carbon chain length between C16 and C18), BIO-BASE™ 220 (linear alpha olefin with a carbon chain length between C14 and C16), BIO-BASE™ 250 (linear alpha olefin with a carbon chain length between C14 and C18), BIO-BASE™ 360 (blend of iso-paraffins and linear paraffins with a carbon chain length between C15 and C16), all are available from Shrieve Chemical Products Company (Woodlands, Tex.). It has been found that the presence of the hydrophobic agglomerating material improves the performance of the pseudoplastic composition and reduces the dusting of the composition and reduces the foam generation when the dry composition is combined with water to form the pseudoplastic composition.

The pseudoplastic composition can include a neutralizer (e.g., a basic neutralizing material.) In many embodiments the basic neutralizing material is any material capable of increasing pH when added to an aqueous material (e.g., forming the aqueous suspension). In many embodiments the basic material includes other neutralizers. In many embodiments, starch at least partially encapsulates particles of the neutralizer or basic neutralizing material (e.g., basic neutralizing particles). In some embodiments the basic neutralizing material includes an amino-methyl-propanol (e.g., 2-amino-2-methly-1-propanol). One commercially available alcohol amine is AMP-95™ and is available from Angus Chemical Company, for example.

The compositions can include a surfactant. In many embodiments the surfactant is a non-ionic surfactant. In some embodiments the non-ionic surfactant includes an alkoxylated alcohol non-ionic surfactant. One commercially available alkoxylated alcohol non-ionic surfactant is Delonic™ LF-EP-61 and is available from DeForest Enterprises Inc., (Boca Raton, Fla.) for example.

In some embodiments, the compositions can include a preservative. The preservative can be any useful preservative utilized in any useful amount. In some embodiments, the preservative is commercially available under the trade designation VANCIDE from R.T. Vanderbilt Company, Inc., Norwalk Conn.

Thus, embodiments of the RAILROAD MAINTENANCE BIODEGRADABLE PSEUDOPLASTIC FIRE SUPRESSION COMPOSITIONS are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of extinguishing or suppressing fire comprising;
applying a pseudoplastic composition onto a railroad track or railroad right-of-way, the pseudoplastic composition clings to a surface positioned in any orientation;
wherein the pseudoplastic composition comprises:
starch;
a pseudoplastic, high yield, suspending agent; and
water.

2. A method according to claim 1 wherein the pseudoplastic composition comprises at least 95% water.

3. A method according to claim 1 wherein the pseudoplastic composition is an aqueous suspension having a pH in the range of 5.0 to 8.0

4. A method according to claim 1 wherein the pseudoplastic composition forms an exterior intumescent char coating upon fire contact.

5. A method according to claim 1 wherein the pseudoplastic composition comprises a basic neutralizing material.

6. A method according to claim 1 wherein the pseudoplastic, high yield, suspending agent comprises a mixture of an acrylic acid copolymer cross linked with a polyalkenyl polyether and a synthetic smectite clay.

7. A method according to claim 1 wherein the applying step comprises spraying the pseudoplastic composition onto a railroad track or railroad right-of-way.

8. A method according to claim 1 wherein the applying step comprises spraying the pseudoplastic composition onto a railroad track.

9. An apparatus comprising:
a railroad vehicle;
a liquid reservoir disposed on the railroad vehicle;
a pseudoplastic composition disposed in the liquid reservoir;
a spray nozzle fluidly connected to the liquid reservoir disposed on the vehicle, the spray nozzle configured to direct the pseudoplastic composition onto a railroad track or railroad right-of-way, the pseudoplastic composition clings to a surface positioned in any orientation;
wherein the pseudoplastic composition comprises:
starch;
a pseudoplastic, high yield, suspending agent; and
water.

10. An apparatus according to claim 9 wherein the pseudoplastic composition comprises at least 95% water.

11. (canceled)

12. An apparatus according to claim 9 wherein the pseudoplastic composition forms an exterior intumescent char coating upon fire contact.

13. (canceled)

14. An apparatus according to claim 9 wherein the pseudoplastic, high yield, suspending agent comprises a mixture of an acrylic acid copolymer cross linked with a polyalkenyl polyether and a synthetic smectite clay.

15. An apparatus according to claim 9 wherein the railroad vehicle is a railroad maintenance vehicle.

16. An apparatus according to claim 9 wherein the railroad vehicle is a railroad rail grinding vehicle.

17. An apparatus for extinguishing or suppressing fire comprising:
a railroad vehicle;
a liquid reservoir disposed on the railroad vehicle;
a pseudoplastic composition disposed in the liquid reservoir;
a spray nozzle fluidly connected to the liquid reservoir disposed on the vehicle, the spray nozzle configured to direct the pseudoplastic composition onto a railroad track or railroad right-of-way, the pseudoplastic composition clings to a surface positioned in any orientation;
wherein the pseudoplastic composition comprises:
starch;
a pseudoplastic, high yield, suspending agent; and
water.

18. An apparatus according to claim 17 wherein the pseudoplastic composition comprises at least 95% water.

19. (canceled)

20. An apparatus according to claim 17 wherein the pseudoplastic composition forms an exterior intumescent char coating upon fire contact.

21. (canceled)

22. An apparatus according to claim 17 wherein the pseudoplastic, high yield, suspending agent comprises a mixture of an acrylic acid copolymer cross linked with a polyalkenyl polyether and a synthetic smectite clay.

23. An apparatus according to claim 17 wherein the railroad vehicle is a railroad maintenance vehicle.

24. An apparatus according to claim 17 wherein the railroad vehicle is a railroad rail grinding vehicle.

25. (canceled)

26. (canceled)

27. (canceled)

28. (canceled)

29. (canceled)
